(19) United States
(12) Patent Application Publication
(10) Pub. No.: US 2026/0254302 A1
(43) Pub. Date: Aug. 27, 2026

(54) ROTOR, FLUID PUMP WITH A ROTOR; AND A METHOD FOR MANUFACTURING THE ROTOR

(71) Applicant: MAHLE International GmbH, Stuttgart (DE)

(72) Inventors: Dieter Hoehn, Hildburghausen (DE); Primoz Pahor, Sela na Krasu 12 (SI); Holger Conrad, Veilsdorf (DE); Torsten Klein, Hildburghausen (DE); Peter Dodel, Sonneberg (DE); Robert Copi, Bovec (SI)

(21) Appl. No.: 19/548,865

(22) Filed: Feb. 24, 2026

(30) Foreign Application Priority Data
Feb. 25, 2025 (DE) 102025107082.2

(51) Int. Cl. H02K 1/32; H02K 7/14; H02K 15/035; H02K 15/121

(52) U.S. Cl. CPC H02K 1/32; H02K 7/14; H02K 15/035; H02K 15/121

(57) ABSTRACT

A rotor includes a rotor core and a sheathing that encases the rotor core at least in sections. The rotor has a plurality of cooling channels, where a radially defined width of at least one of the cooling channels increases axially. A fluid pump with an electric motor having a rotor and a gerotor pump is disclosed. A method for manufacturing a rotor is also disclosed.

### CROSS-REFERENCE TO RELATED APPLICATIONS

This application claims priority to German Patent Application No. DE 102025107082.2 filed on Feb. 25, 2025, the contents of which are hereby incorporated by reference in its entirety.

### TECHNICAL FIELD

The invention relates to a rotor for an electric motor with a rotor core and a sheathing. The invention also relates to a fluid pump with an electric motor and a pump. The invention also relates to a method for manufacturing the rotor.

### BACKGROUND

A fluid pump for conveying a fluid may, for example, comprise an electric motor and a pump driven thereby, e.g., a gerotor pump. During operation of the fluid pump, sufficient cooling of the electric motor and other electrical and/or electronic components of the fluid pump is necessary. For this purpose, a flow path through which the fluid can flow may be provided in the electric motor, with a plurality of cooling channels formed in the rotor. A modified design of the cooling channels can improve the cooling of the electric motor on the one hand, but complicate the manufacturing process of the rotor on the other.

The task of the invention is therefore to provide an improved or at least alternative embodiment for a rotor of the generic type, in which the disadvantages described are overcome. The task of the invention is also to provide a fluid pump with an electric motor having such a rotor and a method for manufacturing the rotor.

According to the invention, this task is solved by the scope of the independent claim(s). Advantageous embodiments are the subject of the dependent claims.

### SUMMARY

The rotor according to the invention is intended and designed for an electric motor of a fluid pump. The rotor has an axis of rotation and a first axial longitudinal end and a second axial longitudinal end. The longitudinal ends of the rotor are arranged axially facing each other. In addition, the rotor comprises a rotor core and a sheathing that encases the rotor core at least in sections. The rotor also comprises an axially aligned shaft opening for accommodating a shaft of the electric motor and is thus annular. The rotor also comprises a plurality of cooling channels that are distributed-in particular evenly-around the axis of rotation and spaced apart from each other. The cooling channels are axially aligned and axially open at the longitudinal ends of the rotor. The cooling channels each have a radially defined width, wherein the width of at least one of the cooling channels increases along the axis of rotation from the first longitudinal end to the second longitudinal end of the rotor, in particular continuously or uniformly.

The rotor is preferably arranged or can be arranged on a shaft of a fluid pump in such a way that, when the fluid pump is operated as intended, fluid flows from the second longitudinal end through the cooling channels to the first longitudinal end. Fluids within the meaning of the invention are understood to be liquids of all kinds, in particular water, glycol, oil, or mixtures thereof, such as a water-glycol mixture.

In the rotor according to the invention, the width of at least one of the cooling channels increases from the first longitudinal end to the second longitudinal end. An imaginary center axis of the respective cooling channel thus runs obliquely to the axis of rotation. This allows the flow through the at least one cooling channel to be influenced. If the electric motor with the rotor according to the invention is arranged such that fluid can flow through it in the fluid pump designed for conveying the fluid, this can influence the suction effect in the at least one cooling channel of the rotor. In particular, this can influence the flow of the fluid flowing through the at least one cooling channel of the rotor during operation when the rotor is rotating, and thus influence the cooling of the electric motor.

The at least one cooling channel may have an outer wall region and an inner wall region. The outer wall region may be located radially outside and extend along the axis of rotation, and the inner wall region may be located radially inside and extend along the axis of rotation. The inner wall region and the outer wall region may merge into one another and delimit the cooling channel transversely to the axis of rotation toward the outside. The outer wall region may be inclined toward the axis of rotation and arranged at the first longitudinal end with a smaller radial distance than at the second longitudinal end. According to one embodiment, the inner wall region may be aligned parallel to the axis of rotation. In other words, the change in width of the at least one cooling channel along the axis of rotation may be defined by the inclination of the outer wall region of the at least one cooling channel. Such a design of the at least one cooling channel may, in particular, simplify the manufacture of the at least one cooling channel.

According to an advantageous embodiment, the rotor has a ring protrusion at its first longitudinal end, wherein at least one of the cooling channels, in particular the cooling channels, is or are arranged radially between the ring protrusion and the shaft opening. The ring protrusion is designed to interact with a corresponding ring extension of a fluid pump in the manner of a labyrinth seal, in particular in such a way that the ring protrusion and the ring extension overlap axially in a concentric arrangement, providing a sealing gap between the ring protrusion and the ring seal, in which fluid flow is minimized during operation compared to adjacent areas. Preferably, the ring protrusion is formed entirely by the sheathing. In particular, the ring protrusion forms an absolute axial end of the rotor.

The rotor core may have a plurality of apertures spaced apart from each other and distributed about the axis of rotation. The openings of the rotor core are axially aligned and are axially open at the longitudinal ends of the rotor. Each opening can have an inner surface and the sheathing can cover the inner surface, in particular at least 80% of the inner surface, in particular at least 90% of the inner surface, in particular at least 95% of the inner surface, of each opening. Each of the cooling channels can be arranged in one of the openings and is bounded radially outwardly transversely to the axis of rotation by the sheathing covering the inner surface of the assigned opening. The outer wall region of the at least one cooling channel described above and/or the inner wall region of the at least one cooling channel described above can then be formed at least in a proportion, in particular predominantly, in particular completely, by the sheathing. A cross-section of the openings of the rotor core defined transverse to the axis of rotation can be constant along the axis of rotation. Alternatively or additionally, the longitudinal center axes of the openings may be aligned parallel to each other and/or to the axis of rotation of the rotor.

In an advantageous embodiment, the rotor has at least two centering openings, in particular blind hole-type openings, at the first longitudinal end, wherein the centering openings are arranged in one of the openings of the rotor core and adjoin the respective inner surface of the respective opening. The respective centering opening is arranged in the respective opening in such a way that the respective cooling channel arranged in the respective opening is located radially between the axis of rotation and the respective centering opening. The respective opening thus borders on the area of the respective inner surface that is radially outside the axis of rotation. The respective cooling channel is preferably spaced from the respective opening exclusively by the sheathing. Preferably, the centering openings are produced by casting the sheathing material, i.e., in particular, by overmolding. This allows the rotor core to be positioned and aligned during the manufacture of the sheathing by means of centering protrusions without impairing the desired formation of the cooling channels.

The sheathing may have a thickness defined transversely to the axis of rotation in the region covering the inner surface of the opening. The thickness of the sheathing may decrease, at least in a section extending along the axis of rotation from the first longitudinal end of the rotor to the second longitudinal end of the rotor, in particular continuously. In other words, the change in the width of the at least one cooling channel can be achieved by changing the thickness of the sheathing within the opening.

The rotor may have an inner sheath surface that radially surrounds the shaft opening. The inner sheath surface may be formed on the rotor core and be free of the sheathing. This allows the rotor to be securely connected to a shaft of the electric motor via the rotor core, for example by means of a press fit. The rotor may have an outer sheath surface aligned parallel to the axis of rotation and extending radially outside the axis of rotation. The outer sheath surface may be formed on the rotor core and be free of the sheathing. This allows electromagnetic interaction between the rotor and a stator of the electric motor to be enhanced.

The rotor core can be made of an electrically conductive material, such as metal or a metal alloy, e.g., steel. The rotor core can have a plurality of rotor sheets that are aligned transversely to the axis of rotation and stacked axially on top of each other. The rotor sheets can be made of an electrically conductive material. The sheathing can generally be advantageously made of an electrically insulating or dielectric material, such as plastic.

The rotor may have a plurality of magnets distributed around the axis of rotation and spaced apart from each other. The magnets may be axially aligned and arranged at least in sections within the rotor core. Each of the cooling channels can be assigned one of the magnets, such that the number of magnets corresponds to the number of cooling channels. The magnet assigned to the cooling channel can be arranged radially outside and at a radial distance from this cooling channel. This can improve the cooling of the areas of the rotor core adjacent to the magnets in particular.

The invention also relates to a fluid pump for conveying a fluid, comprising an electric motor and a pump having at least one pump rotor which is rotatably arranged in a pump chamber of the pump. In particular, the pump is designed as a gerotor pump. The gerotor pump has a driven first pump rotor, in particular an inner rotor, and a second pump rotor, in particular an outer rotor, which is operatively connected to the driven pump rotor and which are rotatably arranged in the pump chamber of the pump. The motor has a shaft, a rotor, and a stator.

The rotor has an axis of rotation and a first axial longitudinal end and a second axial longitudinal end. The longitudinal ends of the rotor are arranged axially facing each other. In addition, the rotor comprises a rotor core and a sheathing that encases the rotor core at least in sections. The rotor also comprises an axially aligned shaft opening for accommodating the shaft and is thus annular. The rotor also comprises a plurality of cooling channels that are distributed evenly around the axis of rotation and spaced apart from each other. The cooling channels are axially aligned and axially open at the longitudinal ends of the rotor. The cooling channels run, in particular, relative to a respective center axis of the respective cooling channel and/or relative to a respective outer wall region, each at a radial distance from the axis of rotation, wherein the radial distance of at least one of the cooling channels along the axis of rotation increases from the first longitudinal end to the second longitudinal end of the rotor, in particular continuously or uniformly. The respective center axis thus runs obliquely to the axis of rotation. As a result, during operation, fluid flowing through the respective cooling channel is guided at least in a proportionate part in the direction of the axis of rotation from the second axial longitudinal end to the first axial longitudinal end through the rotor.

According to a preferred embodiment, the cooling channels each have a radially defined width, wherein the width of at least one of the cooling channels, in particular of the at least one of the cooling channels, increases along the axis of rotation from the first longitudinal end to the second longitudinal end of the rotor, in particular continuously or uniformly. This allows the flow through the at least one cooling channel to be influenced, as described above in connection with the rotor according to the invention.

Generally advantageous, the rotor may have features described above in connection with embodiments of the rotor according to the invention.

The rotor of the fluid pump according to the invention is coaxial and arranged with a radial gap within the stator. The rotor of the motor and the pump rotor, in particular the driven first pump rotor in the gerotor pump embodiment, are connected to the motor shaft in a rotationally fixed manner. The rotor and the pump rotor are arranged axially adjacent to each other and spaced apart on the shaft, wherein, in particular, a separating section of the housing is arranged axially between the rotor and the pump rotor, which provides a bearing for the shaft. The rotor is arranged facing the pump rotor with its first longitudinal end, so that the radial distance and/or the radially defined width of the at least one cooling channel of the rotor along the axis of rotation of the rotor decreases, in particular continuously, towards the pump rotor of the fluid pump. This improves the suction effect in the at least one cooling channel of the rotor. Accordingly, the speed and quantity of the fluid flowing through the at least one cooling channel can be influenced and the cooling of the motor can also be improved.

The motor can have a flow chamber axially adjacent to the second longitudinal end of the rotor. The fluid pump can then have a flow path through which the fluid can flow, and in the flow path, the pump chamber, the gap formed between the rotor and the stator of the electric motor, the flow chamber of the motor, and the plurality of cooling channels of the rotor of the motor can be arranged so that fluid can flow through them. The pump chamber upstream of the gap, the gap upstream of the flow chamber, the flow chamber upstream of the plurality of cooling channels, and the cooling channels upstream of the pump chamber can be arranged so that fluid can flow through them. In other words, part of the fluid conveyed by the pump can be diverted into the flow path and guided through the electric motor. This can improve the cooling of the electric motor. In addition, further electrical and/or electronic components of the fluid pump can be arranged on the outside of a housing pot delimiting the flow chamber to the outside, in particular on the pot base, in a heat-transferring manner and thus be indirectly cooled by the fluid.

It is particularly preferable for the rotor to have a ring protrusion at its first longitudinal end, which is designed to interact with a corresponding annular extension in the manner of a labyrinth seal. In particular, the flow path on both sides of the labyrinth seal runs in opposite directions.

The invention also relates to a method of manufacturing a rotor as described above. In the method, the measures a), b), c), d), e), and f) described below are carried out, preferably one after the other.

In measure a), the rotor core is provided with a plurality of openings each having an inner surface. The openings are distributed uniformly around the axis of rotation and spaced apart from each other.

In measure b), a first mold, in particular a first mold half, is provided with at least two axially aligned centering protrusions and with at least two axially aligned support protrusions. The number of centering protrusions may be exactly two or more than two. The centering protrusions may have an identical radial distance from the axis of rotation of the rotor and may be arranged uniformly distributed around the axis of rotation. The centering protrusions may be arranged symmetrically with respect to each other relative to the axis of rotation of the rotor. The shape of the centering protrusions may be cylindrical or conical or other. The number of support protrusions may be exactly two or more than two. In particular, the number of support protrusions may be identical to the number of cooling channels and/or magnets of the rotor. The support protrusions may have an identical radial distance from the axis of rotation of the rotor and be uniformly distributed around the axis of rotation. The support protrusions may be arranged symmetrically to each other with respect to the axis of rotation of the rotor. In particular, the support protrusions may be arranged axially facing the magnets arranged in the rotor core.

In measure c), the rotor core is arranged on the first mold. The rotor core is arranged axially adjacent to the support protrusions or axially supported so that the rotor core is positioned axially immovably on the first mold. Furthermore, each centering protrusion is arranged within one of the openings of the rotor core and radially outside adjacent to the inner surface of the assigned opening, such that the rotor core is positioned radially immovable and rotationally fixed on the first mold.

In measure d), a second mold, in particular a second mold half, is provided with a plurality of axially aligned channel protrusions. The channel protrusions extend, in particular with reference to a respective center axis of the respective channel protrusion, at a radial distance from the axis of rotation, wherein the radial distance of at least one of the channel protrusions along the axis of rotation increases from the first longitudinal end to the second longitudinal end of the rotor, in particular continuously or uniformly. Alternatively or additionally, a radial width of at least one of the channel protrusions increases from the first longitudinal end to the second longitudinal end of the rotor, in particular continuously. The mold of the channel protrusions corresponds in particular to a desired mold of the cooling channels to be produced in the rotor.

In measure e), the second mold is placed on the rotor core. Each of the protrusions of the second mold is positioned in one of the openings of the rotor core and spaced transversely to the axis of rotation to the inner surface of the assigned opening.

In measure f), a sheathing material is cast between the first mold and the second mold. In measure f), this produces the rotor with the rotor core and the sheathing that encases the rotor core at least in sections. The radially defined width of the at least one cooling channel of the rotor increases, in particular continuously, from the first longitudinal end to the second longitudinal end of the rotor. As already described above, the shape of the cooling channels preferably corresponds to the shape of the protrusions of the second mold.

In the method according to the invention, the rotor core can be arranged radially and axially and non-rotatably between the molds, whereby the manufacturing precision of the rotor can be increased. Due to the higher manufacturing precision of the rotor, the performance of the electric motor can be improved with the rotor manufactured in this way. As already described above, the changing width of the at least one cooling channel of the rotor can also influence and improve the cooling of the electric motor. The rotor with the at least one cooling channel with the varying width can be produced in the method with reduced effort.

In one possible embodiment of the method, the rotor core can be provided with a shaft opening in measure a). In measure b), the first mold and/or in measure d), the second mold can be provided with a shaft protrusion in each case. Then, in measure c), the first mold and/or in measure e), the second mold can be arranged on the rotor core such that the shaft protrusion of the first mold and/or the shaft protrusion of the second mold are arranged in the shaft opening of the rotor core. This allows the rotor core to be arranged on the first mold and/or on the second mold so that it cannot move radially.

In one possible embodiment of the method, the rotor core can be provided in measure a) with a plurality of magnets arranged at least in sections within the rotor core. The number of magnets can correspond to the number of cooling channels and/or the number of support protrusions, as described above. In measure d), the second mold with several axially aligned magnetic protrusions can then be provided. For practical purposes, the number of magnetic protrusions can correspond to the number of magnets. In measure e), the second mold can then be arranged on the rotor core in such a way that the magnetic protrusions of the second mold are axially spaced apart and facing the magnets of the rotor core. When performing measure f), the material of the sheathing can then press the magnets axially away from the magnetic protrusions and into the rotor core, such that the magnets can be precisely positioned axially in the rotor core, thereby increasing the manufacturing precision of the rotor.

In one possible embodiment of the method, in measure c), the rotor core can be arranged with an end assigned with the first longitudinal end of the rotor facing the centering protrusions of the first mold. In measure d), the second mold can then be arranged at an end of the rotor core assigned with the second longitudinal end of the rotor. This makes it easier to remove from the mold or manufacture the at least one cooling channel with the varying width.

In one possible embodiment of the method, the first mold and in measure d) the second mold are provided, in which the centering protrusions of the first mold and the channel protrusions of the second mold are spaced apart transversely to the axis of rotation. This allows, in particular, the cooling channel closed transversely to the axis of rotation to be produced. In particular, this prevents an undesirable flowable connection or a flow-through passage between the cooling channel and an opening in the sheathing remaining after the rotor has been manufactured from the centering protrusion.

In one possible embodiment of the method, measure b) may provide the first mold, in which the centering protrusions engage in the assigned openings of the rotor core to an axially defined depth. The depth can be at least twice as great as an axially defined thickness of a rotor sheet of the rotor core. This allows the rotor core to be arranged particularly securely on the centering protrusions.

In connection with the present invention, the terms “axial”. “radial”, and “circumferential” always refer to the axis of rotation of the rotor. The phrase “transverse to the axis of rotation” is equivalent to the phrase “in a plane aligned transverse to the axis of rotation”.

In connection with the present invention, the description of the simplification process always refers to the axis of rotation of the rotor. It is understood that this reference only applies after completion of measure f)-i.e., when the rotor has already been manufactured and is still located between the first mold and the second mold. The first mold and the second mold are designed in such a way that their longitudinal center axes coincide with each other and with a longitudinal center axis of the rotor core when arranged on the rotor core. The rotor core is designed such that its longitudinal center axis coincides with the axis of rotation of the rotor. Therefore, depending on the context, the reference to the axis of rotation of the rotor is to be understood as a reference to the longitudinal center axis of the first mold and/or to the longitudinal center axis of the second mold and/or to the longitudinal center axis of the rotor core.

Other important features and advantages of the invention can be seen from the dependent claims, from the drawings and from the associated description of the figure based on the drawings.

It is understood that the features mentioned above and those to be explained below may be used not only in the combination indicated in each case, but also in other combinations or on their own, without departing from the scope of the present invention.

Preferred exemplary embodiments of the invention are shown in the drawings by way of example and are explained in more detail in the following description, wherein identical reference signs refer to identical or similar or functionally identical elements.

### RIEF DESCRIPTION OF THE DRAWINGS

The drawings shows, schematically in each case:

FIG. 1 illustrates a view of a rotor according to the invention from its first longitudinal end

FIG. 2 illustrates a view of the rotor according to the invention from its second longitudinal end

FIG. 3 illustrates a radial sectional view of the rotor according to the invention in the area of an opening created by the centering protrusions;

FIG. 4 illustrates a radial sectional view of the rotor according to the invention in the area outside the opening created by the centering protrusions;

FIG. 5 illustrates an axial sectional view of a rotor core of the rotor according to the invention

FIG. 6 illustrates a partial sectional view of a fluid pump according to the invention with an electric motor having the rotor according to the invention.

### DETAILED DESCRIPTION

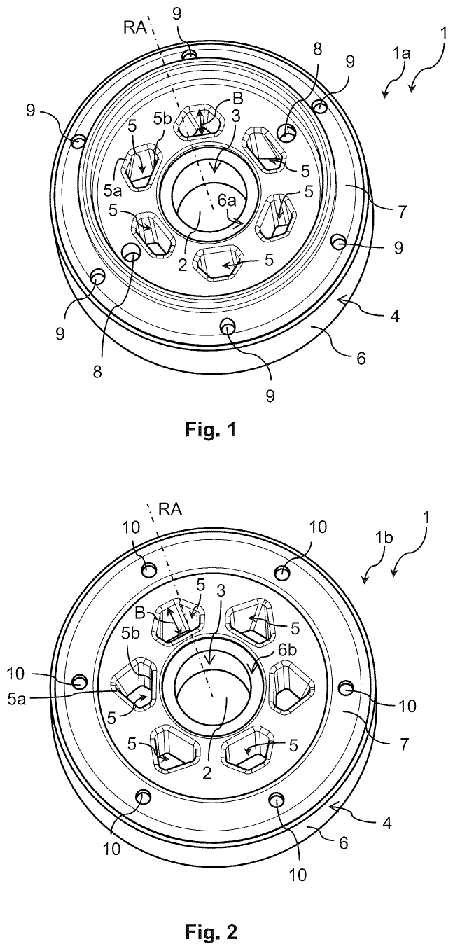

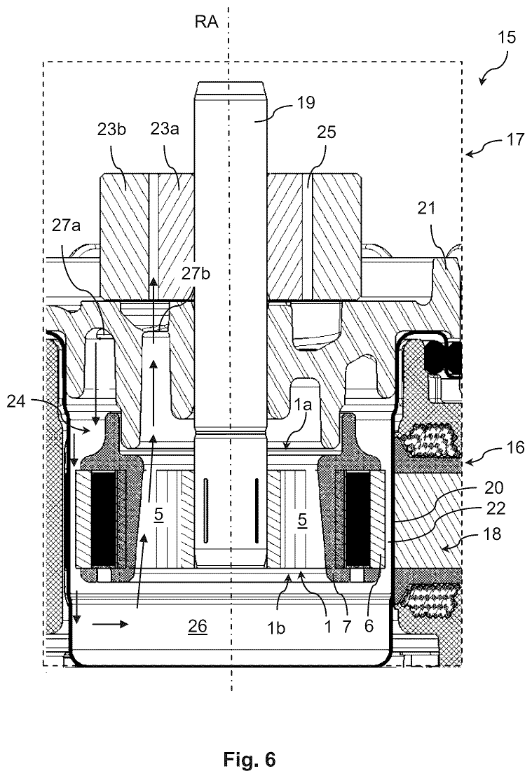

FIG. 1 shows an oblique view of a rotor 1 according to the invention from its first longitudinal end 1a and FIG. 2 shows an oblique view of the rotor 1 according to the invention from its second longitudinal end 1b. The longitudinal ends 1a and 1b of the rotor 1 are arranged axially opposite and at a distance from one another with respect to its axis of rotation RA. The rotor 1 is designed for an electric motor of a fluid pump-see FIG. 6. The rotor 1 also comprises an axially aligned shaft opening 2 for accommodating a shaft of the electric motor. The axis of rotation RA lies within the shaft opening 2 and forms its longitudinal center axis. The rotor 1 is therefore annular and comprises an inner sheath surface 3 aligned parallel to the axis of rotation RA and running radially inside the axis of rotation RA, and an outer sheath surface 4 aligned parallel to the axis of rotation RA and running radially outside the axis of rotation RA. The inner sheath surface 3 radially encloses the shaft opening 2 on the outside and forms an inner surface of the shaft opening 2.

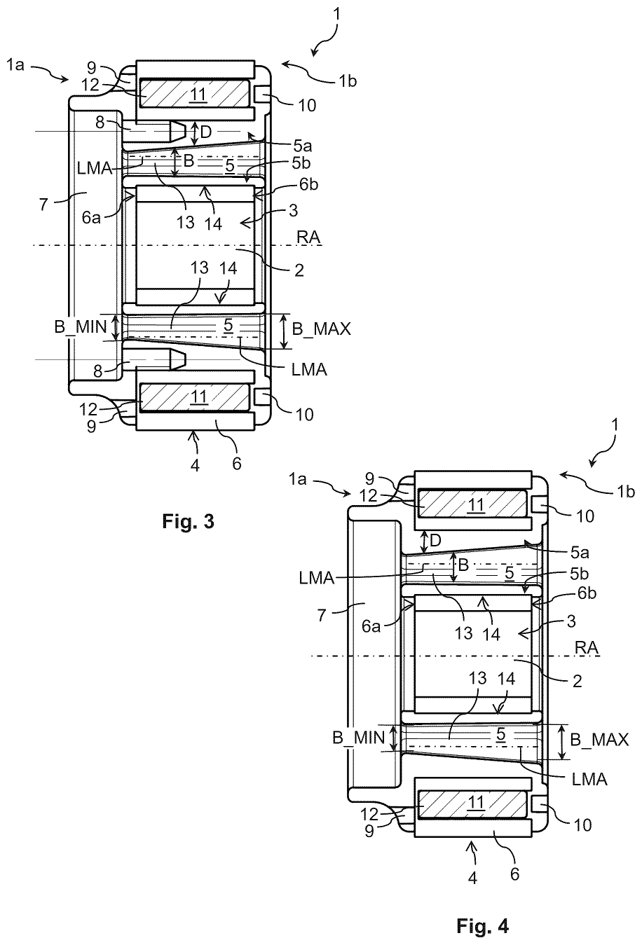

The rotor 1 also comprises a plurality of—in this case exactly six—cooling channels 5, which are uniformly distributed around the axis of rotation RA of the rotor 1 and spaced apart from each other. The cooling channels 5 are axially aligned and open at the longitudinal ends 1a and 1b of the rotor 1. Transverse to the axis of rotation RA, the cooling channels 5 are closed or lie within the rotor 1. The cooling channels 5 each have a radially outer outer wall region 5a and a radially inner inner wall region 5b. The outer wall region 5a and the inner wall region 5b extend along the axis of rotation RA and merge into one another transversely to the axis of rotation RA. A radially defined width B of the cooling channels 5 increases from the first longitudinal end 1a to the second longitudinal end 1b, as explained in more detail below with reference to FIGS. 3 and 4.

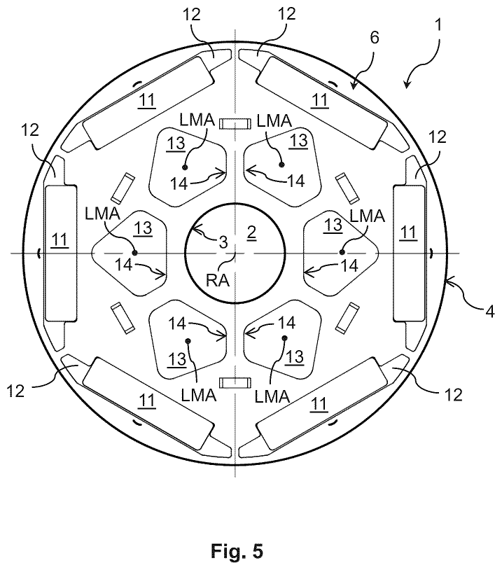

Furthermore, the rotor 1 comprises a rotor core 6 and a sheathing 7 that encases the rotor core 6 in sections. The rotor core 6 is explained in more detail below with reference to FIG. 5. The sheathing 7 is made of plastic and encases the rotor core 6 at its first front surface 6a, which is located at the first longitudinal end 1a and aligned transversely to the axis of rotation RA, and at its second front surface 6b, which is located at the second longitudinal end 1b and aligned transversely to the axis of rotation RA. Furthermore, the sheathing 7 forms the outer wall region 5a and the inner wall region 5b of the respective cooling channel 5. In contrast, the inner sheath surface 3 and, in particular, the outer sheathing surface 4 are free of the sheathing 7, or rather, the rotor core 6 is not covered by the sheathing 7 in these areas and is exposed to the outside.

The rotor 1 can be manufactured in a method according to the invention. In the method, the rotor core 6 is placed between a first mold and a second mold and coated with a material of the sheathing 7. The first mold is placed at the first longitudinal end 1a of the rotor 1 and the second mold is placed at the second longitudinal end 1b of the rotor 1. FIG. 1 shows a plurality of—in this case exactly two—centering openings 8 corresponding to centering protrusions of the first mold and a plurality of—in this case exactly six—support openings 9 corresponding to support protrusions of the first mold. FIG. 2 also shows a plurality of—in this case exactly six—magnet openings 10 corresponding to magnet protrusions of the second mold. The alignment of the molds on the rotor core 6 is explained in more detail below with reference to FIG. 3 and FIG. 4.

FIG. 3 shows a radial sectional view of the rotor 1 according to the invention in the area of the centering openings 8 created by the centering protrusions. FIG. 4 shows a radial sectional view of the rotor 1 according to the invention in the area outside the centering openings 8 created by the centering protrusions. As can be seen in FIG. 3 and FIG. 4, the rotor 1 comprises, in addition to the rotor core 6 and the sheathing 7, several magnets 11, in this case exactly six. The magnets 11 are axially aligned and arranged in assigned axially aligned and axially closed pockets 12 of the rotor core 6. The magnets 11 are uniformly distributed around the axis of rotation RA and are spaced radially opposite the cooling channels 5.

With reference to FIG. 3 and FIG. 4, the rotor core 6 also comprises an opening 13 with an inner surface 14 for each cooling channel 5. The openings 13 are axially aligned and pass through the rotor core 6. A cross-section of the openings 13 defined transversely to the axis of rotation RA is constant along the axis of rotation RA and longitudinal center axes LMA of the openings 13 are aligned parallel to the axis of rotation RA. The changing radial width B of the cooling channels 5 is achieved by a changing thickness D of the sheathing 7 in the outer wall regions 5a of the cooling channels 5. This results in a center axis for each of the cooling channels 5, which is aligned obliquely to the axis of rotation RA in correspondence with the changing radial width B, in particular so that the center axes intersect outside the rotor 1. The thickness D of the sheathing 7 is greater at the first longitudinal end 1a of the rotor 1 than at the second longitudinal end 1b of the rotor 1, and correspondingly, the radial width B of the cooling channels 5 is smaller at the first longitudinal end 1a of the rotor 1 than at the second longitudinal end 1b of the rotor 1. The cooling channels 5 reach their minimum width B_MIN at the first longitudinal end 1a of the rotor and their maximum width B_MAX at the second longitudinal end 1b of the rotor 1. In principle, however, it is also conceivable that the thickness of the sheathing 7 at the inner wall region 5b could be varied in a manner complementary to the thickness D, such that the radial distance of the respective cooling channel 5 at the second longitudinal end 1b is greater than at the first longitudinal end 1a, without this requiring a change in thickness.

With reference to FIG. 3, when manufacturing the rotor 1, the rotor core 6 is arranged on the first mold assigned with the first longitudinal end 1a of the rotor 1. As can be seen from the arrangement and alignment of the support openings 9 created by the protrusions of the first mold, the rotor core 1 is axially supported on the support protrusions of the first mold and thereby axially fixed to the first mold. As can be seen from the arrangement and alignment of the centering openings 8 created by the centering protrusions of the first mold, the centering protrusions of the first mold are arranged in the openings 13 of the rotor core 6. The centering protrusions of the first mold are arranged radially outwardly adjacent to the inner surfaces 14 of the assigned openings 13. This fixes the rotor core 6 radially and rotationally to the first mold. With reference to FIG. 4, during the manufacture of the rotor 1, the second mold assigned with the second longitudinal end 1b of the rotor 1 is arranged on the rotor core 6. As can be seen from the arrangement and orientation of the magnetic openings 10 created by the magnetic protrusions of the second mold, the magnetic protrusions of the second mold are arranged axially facing and spaced apart from the magnets 11. With reference to FIG. 3, channel protrusions of the second mold are also arranged in the openings 13 such that they are spaced transversely to the axis of rotation RA from the inner surfaces 14 of the openings 13 and, in particular, from the centering protrusions of the first mold. This prevents an unwanted flow-through connection between the cooling channel 5 and the centering opening 8 adjacent to this cooling channel 5 in the manufactured rotor 1. The width and/or shape of the centering opening 8 or the centering protrusion of the first mold and the width and/or shape of the cooling channel 5 or the channel protrusion of the second mold can be adapted to each other accordingly. After positioning and aligning the rotor core 6 on the first mold and the second mold on the rotor core 6, a material for the sheathing 7 is then cast between the molds, thereby producing the rotor 1 with the rotor core 6 and the sheathing 7.

FIG. 5 shows an axial sectional view of the rotor core 6 of the rotor 1 according to the invention with magnets 11. As can be seen in FIG. 6, the magnets 11 are arranged in the pockets 12 of the rotor core 6. It can also be seen that the magnets 11 are radially spaced apart from the openings 13 and thus facing the cooling channels 5 of the rotor 1 arranged in the openings 13. It can also be seen that the contour of the openings 13 is designed at least in sections in the form of a polygon, in this case a pentagon, which enables an improved arrangement of the functionally relevant areas of the rotor 1 across its cross-section and is generally advantageous.

FIG. 6 shows a partial sectional view of a fluid pump 15 according to the invention with an electric motor 16 and a gerotor pump 17.

The electric motor 16 comprises a stator 18, the rotor 1 described above, a shaft 19, a housing pot 20, and a housing 21, of which the separating section is shown in FIG. 6. The rotor 1 and the stator 18 are arranged on the housing 21 in the housing pot 20, wherein the rotor 1 is accommodated coaxially and with a radial circumferential gap 22 in the stator 18. The stator 18 is arranged in a so-called dry area of the fluid pump 15 and the rotor 1 is arranged in a so-called wet area of the fluid pump 15. The dry area or stator 18 and the wet area or rotor 1 are separated from each other in a fluid-tight manner by the housing pot 20 arranged on the housing 21.

The rotor 1 is connected to the shaft 19 in a rotationally fixed manner—for example, via a press fit—and is arranged with its first longitudinal end 1a facing the Gerotor pump 17. The shaft 19 protrudes from the housing 21 at the first longitudinal end 1a of the rotor 1 and is connected to the Gerotor pump 17. The Gerotor pump 17 comprises a driven pump rotor 23a (inner rotor) and a pump rotor 23b (outer rotor) connected to it in a functional manner. The driven pump rotor 23a is connected to the shaft 19 in a rotationally fixed manner, for example via a press fit, and can therefore be driven by the electric motor 16 when the rotor 1 rotates.

The fluid pump 15 is designed to convey a fluid and comprises a flow path 24 through which the fluid can flow to cool the electric motor 16 during operation. The flow path 24 comprises a pump chamber 25 of the Gerotor pump 17, which is formed in particular between the pump rotors 23a and 23b, the gap 22 formed between the rotor 1 and the stator 18, a flow chamber 26 of the electric motor 16 formed between the second longitudinal end 1b of the rotor 1 and the housing pot 20, and the cooling channels 5 of the rotor 1. As indicated by arrows in FIG. 6, the fluid flows in the flow path 24 from the pump chamber 25 through at least one through-opening 27a to the gap 22 and further via the gap 22 into the flow chamber 26. From the flow chamber 26, the fluid flows through the cooling channels 5 of the rotor 1 and through at least one through-opening 27b back into the pump chamber 25. The respective through-openings 27a and 27b are formed in the separating section of the housing 21 located between the Gerotor pump 17 and the rotor 1.

The rotor 1 of the electric motor 16 can be cooled by flowing through the gap 22 and the cooling channels 5. When flowing through the flow chamber 26, the rotor 1 of the electric motor 16 and, in addition, at least one component of the fluid pump 15 arranged outside the housing pot 20, in particular at the pot base, for heat transfer purposes-for example, a control board or printed circuit board-can be cooled indirectly. Due to the decreasing width of the cooling channels 5 from the flow chamber 26 to the gerotor pump 17, the flow of the fluid in the cooling channels 5 and in the electric motor 16 can be intensified overall, thereby intensifying its cooling.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments. “One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A rotor for an electric motor of a fluid pump, comprising:
a first axial longitudinal end and a second axial longitudinal end facing the first longitudinal end, the rotor having an axis of rotation,
a rotor core and a sheathing that encases the rotor core at least in sections,
an axially aligned shaft opening for accommodating a shaft of the electric motor, the shaft opening having an annular shape,
a plurality of cooling channels distributed around the axis of rotation and arranged spaced apart from each other,
the plurality of cooling channels are axially aligned and are axially open at the first and second longitudinal ends, and
wherein the plurality of cooling channels each have a radially defined width and the width of at least one of the plurality of cooling channels increases along the axis of rotation from the first longitudinal end to the second longitudinal end.

2. The rotor according to claim 1, wherein:
the at least one cooling channel has an outer wall region located radially on an outside and extending along the axis of rotation and an inner wall region located radially on an inside and extending along the axis of rotation,
the outer wall region of the at least one cooling channel is inclined relative to the axis of rotation and has a smaller radial distance to the axis of rotation at the first longitudinal end than at the second longitudinal end, and
the inner wall region of the at least one cooling channel is aligned parallel to the axis of rotation.

3. The rotor according to claim 1, wherein:
the rotor core has a plurality of openings distributed around the axis of rotation and arranged spaced apart from each other,
the plurality of openings of the rotor core are axially aligned and are axially open at the first and second longitudinal ends,
each opening of the plurality of openings has an inner surface and the sheathing covers the inner surface of each opening, and
each of the plurality of cooling channels is arranged in one of the plurality of openings and is bounded radially outwardly transversely to the axis of rotation by the sheathing covering the inner surface of an associated one of the plurality of openings.

4. The rotor according to claim 3, wherein:
a cross-section of the plurality of openings defined transversely to the axis of rotation is constant along the axis of rotation, and/or
longitudinal center axes of the plurality of openings are aligned parallel to each other and/or to the axis of rotation.

5. The rotor according to claim 3, wherein:
the sheathing has a thickness defined transversely to the axis of rotation in a region covering the inner surface of the opening, and
the thickness of the sheathing decreases at least in a section extending along the axis of rotation from the first longitudinal end to the second longitudinal end.

6. The rotor according to claim 1, further comprising:
an inner sheath surface radially surrounding the shaft opening, and the inner sheath surface is formed on the rotor core and is free of the sheathing, and/or
an outer sheath surface aligned parallel to the axis of rotation and running radially outside the axis of rotation, and that the outer sheath surface is formed on the rotor core and is free of the sheathing.

7. The rotor according to claim 1, wherein:
a plurality of magnets are distributed around the axis of rotation and arranged spaced apart from each other,
the plurality of magnets are axially aligned and arranged at least in sections within the rotor core, and
each of the plurality of cooling channels is assigned one of the plurality of magnets and the magnet assigned to the cooling channel is arranged radially outside and at a radial distance from the cooling channel.

8. The rotor according to claim 1, wherein:
at least two centering openings are disposed at the first longitudinal end,
the at least two centering openings are each arranged in one of a plurality of openings disposed in the rotor core and adjoin a respective inner surface of the respective opening, and
the at least two centering openings are each arranged in the respective opening such that the respective cooling channel arranged in the respective opening lies radially between the axis of rotation and the respective centering opening.

9. A fluid pump for conveying a fluid, comprising:
an electric motor and a pump,
the pump including at least one pump rotor in a pump chamber,
the motor including a shaft, a rotor, and a stator,
the rotor including:
a first axial longitudinal end and a second axial longitudinal end facing the first longitudinal end, the rotor having an axis of rotation,
a rotor core and a sheathing that encases the rotor core at least in sections,
an axially aligned shaft opening for accommodating a shaft of the electric motor, the shaft opening having an annular shape,
a plurality of cooling channels distributed around the axis of rotation and arranged spaced apart from each other,
the plurality of cooling channels are axially aligned and are axially open at the first and second longitudinal ends, and
wherein the plurality of cooling channels each have a radially defined width and the width of at least one of the plurality of cooling channels increases along the axis of rotation from the first longitudinal end to the second longitudinal end
wherein the rotor of the motor is arranged coaxially and with a radial gap within the stator of the motor,
wherein the rotor of the motor and the at least one pump rotor are connected to the shaft of the motor in a rotationally fixed manner and are arranged on the shaft axially adjacent to and spaced apart from each other, and
wherein the rotor of the motor is arranged with the first longitudinal end facing the at least one pump rotor,
wherein the plurality of cooling channels of the rotor, which are axially aligned and axially open at the first and second longitudinal ends of the rotor and are distributed around the axis of rotation of the rotor and arranged spaced apart from each other, each extend at a radial distance from the axis of rotation,
wherein the radial distance of at least one of the plurality of cooling channels along the axis of rotation increases from the first longitudinal end to the second longitudinal end of the rotor,
such that the radial distance of the at least one cooling channel of the rotor along the axis of rotation of the rotor toward the at least one pump rotor decreases.

10. The fluid pump according to claim 9, wherein:
the motor has a flow chamber axially adjacent to the second longitudinal end of the rotor,
a flow path through which the fluid can flow is provided, and in the flow path the pump chamber is disposed upstream of the gap between the rotor and the stator of the motor, and the gap is upstream of the flow chamber of the motor, and the flow chamber is upstream of the plurality of cooling channels of the rotor of the motor and the plurality of cooling channels are upstream of the pump chamber so that fluid can flow through them.

11. A method for manufacturing a rotor, comprising:
a. providing a rotor core with a plurality of openings distributed around an axis of rotation of the rotor and spaced apart from each other, each of the plurality of openings provided with an inner surface,
b. providing a first mold with at least two axially aligned centering protrusions and with at least two axially aligned support protrusions,
c. arranging the rotor core on the first mold,
wherein the rotor core is arranged axially adjacent to the at least two support protrusions, such that the rotor core is positioned axially immovably on the first mold,
wherein each of the at least two centering protrusions is arranged within one of the plurality of openings of the rotor core and radially outside adjacent to the inner surface of the assigned opening, such that the rotor core is positioned radially immovable and rotationally fixed on the first mold,
d. providing a second mold with a plurality of axially aligned channel protrusions, wherein a radial width of at least one of the plurality of channel protrusions increases from a first longitudinal end to a second longitudinal end of the rotor,
e. arranging the second mold on the rotor core,
wherein the second mold is arranged on the rotor core such that each of the plurality of channel protrusions of the second mold is arranged in one of the plurality of openings of the rotor core and spaced transversely to the axis of rotation from the inner surface of the assigned opening,
f. casting a material of a sheathing between the first mold and the second mold, thereby producing the rotor with the rotor core and the sheathing at least in sections encasing the rotor core, wherein a radially defined width of at least one of the plurality of cooling channels of the rotor increases from the first longitudinal end to the second longitudinal end of the rotor.

12. The method according to claim 11, wherein:
in measure a), the rotor core is provided with a shaft opening,
in measure b) the first mold and/or in measure d) the second mold is provided with a shaft protrusion in each case, and
in measure c) the first mold and/or in measure e) the second mold are arranged on the rotor core such that the shaft protrusion of the first mold and/or the second mold is arranged in the shaft opening of the rotor core.

13. The method according to claim 11, wherein:
in measure a) the rotor core is provided with a plurality of magnets arranged at least in sections within the rotor core,
in measure d) the second mold is provided with a plurality of axially aligned magnetic protrusions, and
in measure e) the second mold is arranged on the rotor core such that the plurality of magnetic protrusions of the second mold are arranged axially spaced apart and axially opposite the plurality of magnets of the rotor core.

14. The method according to claim 11, wherein:
in measure c), the rotor core is arranged with an end assigned with the first longitudinal end of the rotor facing the at least two centering protrusions of the first mold, and
in measure d), the second mold is arranged at an end of the rotor core assigned with the second longitudinal end of the rotor.

15. The method according to claim 11, wherein:
in measure b) the first mold and in measure d) the second mold are provided, in which the at least two centering protrusions of the first mold and the plurality of channel protrusions of the second mold are spaced apart transversely to the axis of rotation.

16. The method according to claim 11, wherein:
in measure b), the first mold is provided, in which the at least two centering protrusions engage in the assigned openings of the rotor core to an axially defined depth that is at least twice as great as an axially defined thickness of a rotor sheet of the rotor core.

17. The fluid pump according to claim 9, wherein:
the radial distance of the at least one cooling channel increases continuously from the first longitudinal end to the second longitudinal end; and/or
the radial distance of the at least one cooling channel decreases continuously toward the at least one pump rotor.

18. The fluid pump according to claim 9, wherein:
the at least one cooling channel has an outer wall region located radially on an outside and extending along the axis of rotation and an inner wall region located radially on an inside and extending along the axis of rotation,
the outer wall region of the at least one cooling channel is inclined relative to the axis of rotation and has a smaller radial distance to the axis of rotation at the first longitudinal end than at the second longitudinal end, and
the inner wall region of the at least one cooling channel is aligned parallel to the axis of rotation.

19. The fluid pump according to claim 9, wherein:
the rotor core has a plurality of openings distributed around the axis of rotation and arranged spaced apart from each other,
the plurality of openings of the rotor core are axially aligned and are axially open at the first and second longitudinal ends,
each opening of the plurality of openings has an inner surface and the sheathing covers the inner surface of each opening, and
each of the plurality of cooling channels is arranged in one of the plurality of openings and is bounded radially outwardly transversely to the axis of rotation by the sheathing covering the inner surface of an associated one of the plurality of openings.

20. The rotor according to claim 1, wherein the width of the at least one cooling channel increases continuously from the first longitudinal end to the second longitudinal end.
